(19) United States
(12) Patent Application Publication
(10) Pub. No.: US 2026/0035216 A1
(43) Pub. Date: Feb. 5, 2026

(54) CLAW ADJUSTMENT DEVICE FOR A CRANE MACHINE

(71) Applicant: PAOKAI ELECTRONIC ENTERPRISE CO., LTD., Kaohsiung City (TW)

(72) Inventors: Ming-Shan WEI, Kaohsiung City (TW); Tung-Ying WEI, Kaohsiung City (TW)

(21) Appl. No.: 18/911,772

(22) Filed: Oct. 10, 2024

(30) Foreign Application Priority Data
Jul. 30, 2024 (TW) 113208106

(51) Int. Cl. B66C 1/42

(52) U.S. Cl. CPC B66C 1/425

(57) ABSTRACT

A claw adjustment device is adapted to be installed to a claw device that includes a plurality of claw bodies, and includes a carrying seat, an adjusting plate, and a positioning tenon. The carrying seat has a core seat portion that has a plurality of positioning holes, and a plurality of pivot seat portions that extend from the core seat portion, and that are adapted to be connected to the claw bodies. Each of the pivot seat portions is formed with a slot. The adjusting plate has a plurality of extension portions that respectively cover top ends of the slots. The adjusting plate is operable to rotate relative to the carrying seat so that an extent to which each of the extension portions covers the top end of the respective one of the slots is adjustable. The positioning tenon is operable to be inserted into one of the positioning holes.

### CROSS-REFERENCE TO RELATED APPLICATION

This application claims priority to Taiwanese Utility Model Patent application Ser. No. 11/320,8106, filed on Jul. 30, 2024, the entire disclosure of which is incorporated by reference herein.

### FIELD

The disclosure relates to an adjustment device, and more particularly to a claw opening and closing adjustment device for a crane machine.

### BACKGROUND

Referring to FIG. 1, a claw device 1 of a conventional crane machine includes a driving member 11, a core rod 12 that is coaxially mounted to the driving member 11, a carrying seat 13 that is connected to a bottom end of the core rod 12, a plurality of claw bodies 14 that are equiangularly spaced apart from each other about the carrying seat 13 and that are pivotably connected to the carrying seat 13, and a plurality of linkage rods 15 each of which interconnects the driving member 11 and a respective one of the claw bodies 14. The driving member 11 is capable of driving the core rod 12 to extend or retract via internal coils thereof so that the carrying seat 13 is moved downwardly or upwardly. When the carrying seat 13 is moved upwardly to a highest position of its range of motion, one end of each of the claw bodies 14 that is pivotably connected to the carrying seat 13 is urged to move upwardly to its highest position accordingly. At this time, each of the claw bodies 14 swings about a joint of the claw body 14 and the respective one of the linkage rods 15 such that another end of each of the claw bodies 14 which is not connected to the carrying seat 13 is moved downwardly and inwardly, and that the another ends of the claw bodies 14 simultaneously approach each other (i.e., the claw bodies 14 are closed). Therefore, the claw bodies 14 can cooperate with each other to grip an object. Conversely, as the carrying seat 13 is urged to move downwardly to a lowest point of its range of motion, the another ends of the claw bodies 14 are simultaneously moved away from each other (i.e., the claw bodies 14 are open). Therefore, the claw bodies 14 can put the object down. However, in the claw device 1 that adopts the abovementioned design, an extent to which the claw bodies 14 can open or close is limited to a particular range. Thus, when prizes that are placed in the conventional crane machine vary in sizes and when there is a significant difference in size among the prizes, the claw devices 1 may need to be replaced with another claw device that has a different range of opening and closing from the claw device 1 so as to be suitable for the prizes. Consequently, an owner of the conventional crane machine needs not only to spend more money on purchasing claw devices of multiple specifications, but also needs to frequently replace the claw devices during operation of the conventional crane machine. The claw devices 1 is thus inconvenient to use.

Referring to FIG. 2, in view of the abovementioned drawback of the claw device 1, a claw device 7 whose degree of opening/closing is adjustable is disclosed in Taiwanese Utility Model Patent No. M653297. The claw device 7 includes a core rod 72, a spring 761, a carrying seat 73, an adjustment plate 762, and a plurality of claw bodies 74. The spring 761 is sleeved on the core rod 72. The adjustment plate 762 is sleeved on the core rod 72, and is located between the spring 761 and the carrying seat 73. The adjustment plate 762 is generally disc-shaped, and has a plurality of grooves 763 each of which is recessed from an outer circumferential periphery thereof in a radial direction. Lengths of the grooves 763 are different. The grooves 763 are divided into a number of groove groups that corresponds to a number of the claw bodies 74. The lengths of the grooves 763 in a same groove group are different. Each of the claw bodies 74 corresponds in position to one of the grooves 763 in a respective one of the groove groups in the radial direction. When the claw bodies 74 swing upwardly, each of the claw bodies 74 enters the one of the grooves 763 in the respective one of the groove groups until the swing movement is stopped by a closed end of the one of the grooves 763 in the respective one of the groove groups. The adjustment plate 762 is operable to rotate so that the claw bodies 74 can correspond in position to another one of the grooves 763 in the respective one of the groove groups, thereby adjusting an extent to which the claw bodies 74 can open. However, although the spring 761 presses the adjustment plate 762 in an axial direction of the core rod 72 to restrict upward movement of the adjustment plate 762, rotation movement of the adjustment plate 762 is not restricted by the claw bodies 74 because the claw bodies 74 may completely be separated from the grooves 763 when the claw bodies 74 are in operation. Therefore, the adjustment plate 762 may easily rotate under an external force or vibration, which makes any one of the grooves 763 in each of the groove groups unable to be aligned with the respective one of the claw bodies 74. At this time, the claw bodies 74 are blocked by the adjustment plate 762 such that the claw bodies 74 only have a minimum of the degree of opening. When the claw bodies 74 are urged to move by a larger operating force, the adjustment plate 762 may be bent and damaged by the claw bodies 74. Furthermore, because the grooves 763 are recessed from the outer circumferential periphery of the adjustment plate 762, the grooves 763 may not be too close to each other if structural strength of the adjustment plate 762 is taken into account, which limits the number of the grooves 763. Consequently, a number of degrees of opening that the claw bodies 74 can be adjusted may not be enough and may be limited.

Referring to FIG. 3, another claw device 8 whose degree of opening/closing is adjustable is disclosed in Taiwanese Invention U.S. Pat. No. 1,809,264. The claw device 8 includes a core rod 82, a spring 871, a carrying seat 83, an adjustment plate 862, a plurality of claw bodies 84, and an insert rod 872. The adjustment plate 862 is a polygonal plate with a number of sides that corresponds to a number of the claw bodies 84. The adjustment plate 862 is formed with a plurality of through holes 864 that are arranged in a circumferential 15 direction of the core rod 82. The carrying seat 83 has a blind hole 831 in which the spring 871 and the insert rod 872 are accommodated. The spring 871 resiliently biases the insert rod 872 upwardly so that when the insert rod 872 is aligned with one of the through holes 864, the insert rod 872 is inserted into the one of the through holes 864 to position the adjustment plate 862. Via a particular geometric shape of the adjustment plate 862, when the adjustment plate 862 is rotated to a different position relative to the carrying seat 83, the adjustment plate 862 may limit swing movements of the claw bodies 84 with different portions thereof, thereby achieving an effect of adjusting degree of opening of the claw bodies 84. However, when there is a need to adjust the degree of opening of the claw bodies 84, a needle-shaped tool is needed for pressing the insert rod 872 downwardly so as to remove the insert rod 872 from the one of the through holes 864, and then rotation of the adjustment plate 862 is thus allowed for adjusting the degree of opening of the claw bodies 84. Because the abovementioned adjustment requires an additional tool, and because it is difficult to align the additional tool with the insert rod 872 and then press the insert rod 872 due to a small size of the insert rod 872, operation of the adjustment is difficult and inconvenient.

### SUMMARY

Therefore, an object of the disclosure is to provide a claw adjustment device for a crane machine that can alleviate at least one of the drawbacks of the prior art.

According to the disclosure, the claw adjustment device is adapted to be installed to a claw device of the crane machine. The claw device includes a driving member, a core rod that is retractably mounted to the driving member, a plurality of linkage rods that are circumferentially spaced apart from each other about the driving member, and a plurality of claw bodies that are respectively connected to the plurality of linkage rods. Each of the plurality of linkage rods has one end that is connected to the driving member. The claw adjustment device includes a carrying seat, an adjusting plate, a resilient member, and a positioning tenon. The carrying seat has a core seat portion that is adapted for abutting against the core rod, and a plurality of pivot seat portions that extend radially and outwardly from the core seat portion, and that are adapted to be respectively and pivotably connected to the plurality of claw bodies. The core seat portion has a plurality of positioning holes that open upwardly and that are arranged in a circumferential direction about an axis which extends through the carrying seat. Each of the plurality of pivot seat portions is formed with a slot that extends therethrough in an extending direction of the axis, and that is adapted for the respective one of the plurality of claw bodies to extend thereinto and for positioning the respective one of the plurality of claw bodies. The adjusting plate is disposed between the carrying seat and the core rod, and has a core plate portion that is placed on the core seat portion of the carrying seat and that has a plate through hole which is adapted for the core rod to extend therethrough, and a plurality of extension portions that extend radially and outwardly from the core plate portion and that respectively cover top ends of the plurality of slots. The adjusting plate is operable to rotate relative to the carrying seat so that an extent to which each of the plurality of extension portions covers the top end of the respective one of the plurality of slots is adjustable. The resilient member is disposed between the core rod and the adjusting plate, and resiliently biases the core plate portion of the adjusting plate downwardly in the extending direction of the axis. The positioning tenon extends downwardly from the core plate portion of the adjusting plate, and is operable to be inserted into one of the plurality of positioning holes.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a general claw device of a crane machine.

FIG. 2 is a perspective view of a claw device disclosed in Taiwanese Utility Model Patent No. M653297.

FIG. 3 is a partly exploded perspective view of another claw device disclosed in Taiwanese Invention U.S. Pat. No. 1,809,264.

FIG. 4 is a perspective view illustrating an embodiment of a claw adjustment device for a crane machine according to the present disclosure.

FIG. 5 is a fragmentary, partly exploded perspective view, illustrating how components of the embodiment are assembled.

FIG. 6 is a perspective view illustrating a carrying seat of the embodiment.

FIG. 7 is a perspective view of an adjusting plate of the embodiment.

FIG. 8 is a perspective view illustrating a modification of the adjusting plate.

FIG. 9 is a fragmentary top view illustrating the embodiment.

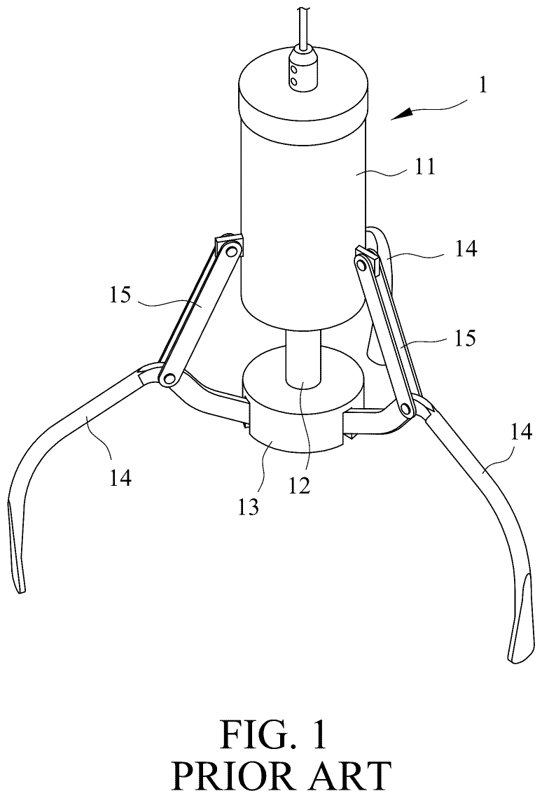

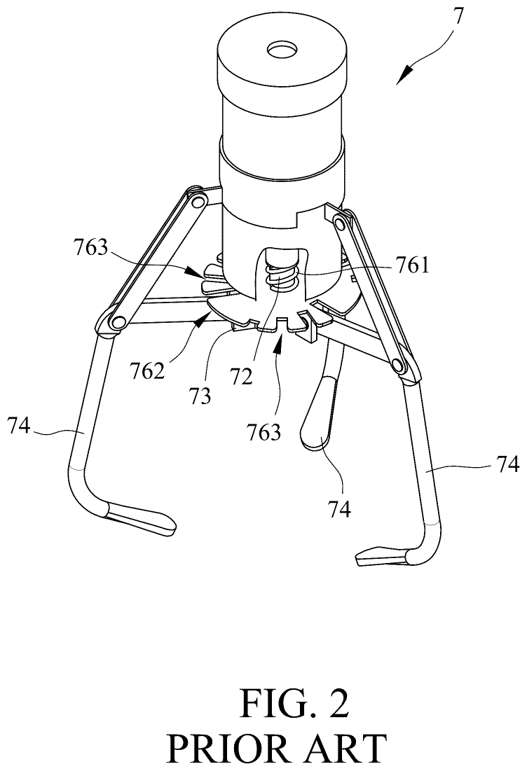

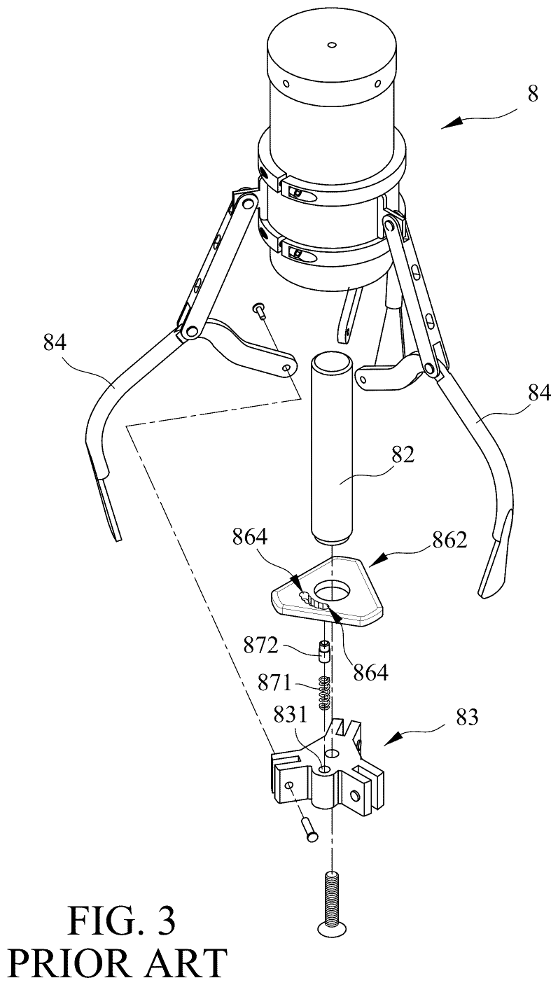

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

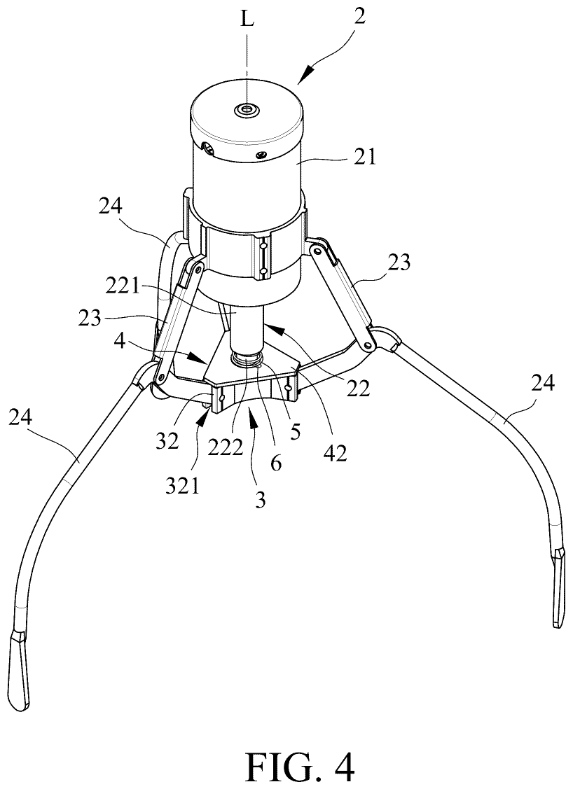

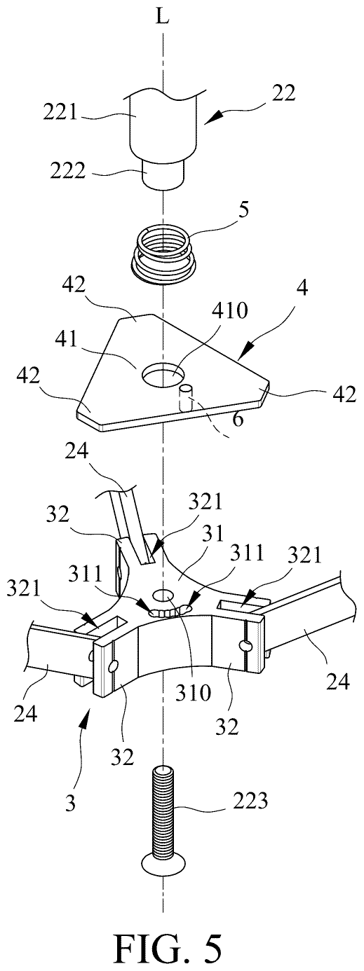

Referring to FIGS. 4 and 5, an embodiment of a claw adjustment device for a crane machine (not shown) according to the present disclosure is adapted to be installed to a claw device 2 of the crane machine. The claw device 2 includes a driving member 21, a core rod 22 that is retractably mounted to the driving member 21, three linkage rods 23 (only two of the linkage rods 23 are visible due to a viewing angle of FIG. 4) that are circumferentially spaced apart from each other about the driving member 21, and three claw bodies 24 that are respectively connected to the linkage rods 23. Each of the linkage rods 23 has one end that is pivotably connected to the driving member 21. The core rod 22 includes a main rod portion 221 that is inserted into the driving member 21, an end rod portion 222 that extends downwardly from a bottom end of the main rod portion 221 in an extending direction of an axis (L) and that has a diameter smaller than a diameter of the main rod portion 221, and a fixing portion 223 that is fixedly fastened to a bottom end of the end rod portion 222. One end of the main rod portion 221 that is located in the driving member 21 is generally provided with a magnet so that when the driving member 21 generates a magnetic field via an inner coil thereof, the core rod 22 may be pushed away or attracted by the driving member 21 in the extending direction of the axis (L). The fixing portion 223 may be configured to be a bolt, and is fastened to the bottom end of the end rod portion 222 from bottom up in the extending direction of the axis (L).

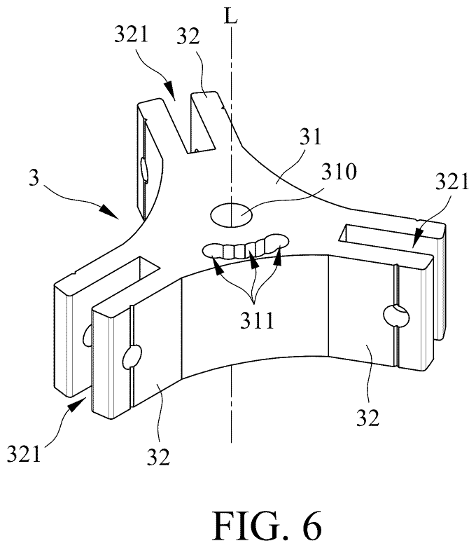

Referring to FIGS. 4, 5, and 6, the claw adjustment device includes a carrying seat 3 that is adapted for abutting against the end rod portion 222 of the core rod 22, an adjusting plate 4 that is placed on the carrying seat 3 (i.e., the adjusting plate 4 is disposed between the carrying seat 3 and the core rod 22) and that has a plate through hole 410 adapted for the end rod portion 222 to extend therethrough, a resilient member 5 that is adapted to be sleeved on the end rod portion 222 and that has two opposite ends respectively abutting against the main rod portion 221 and the adjusting plate 4 (i.e., the resilient member 5 is disposed between the core rod 22 and the adjusting plate 4), and a positioning tenon 6 that extends downwardly from a bottom surface of the adjusting plate 4. The axis (L) extends through the carrying seat 3.

The carrying seat 3 has a core seat portion 31 that is fixedly clamped between the end rod portion 222 and the fixing portion 223 of the core rod 22 in the extending direction of the axis (L) (i.e., the core seat portion 31 is adapted for abutting against the end rod portion 222), and three pivot seat portions 32 that extend radially and outwardly from the core seat portion 31, and that are adapted to be respectively and pivotably connected to the claw bodies 24. The core seat portion 31 is formed with a seat through hole 310 that is adapted for the fixing portion 223 of the core rod 22 to extend therethrough, and has a plurality of positioning holes 311 that open upwardly and that are arranged in a circumferential direction about the axis (L). The positioning holes 311 may be blind holes or through holes. In this embodiment, as shown in FIG. 5, the positioning holes 311 are in spatial communication with each other in the circumferential direction so that a density and a number of the positioning holes 311 may be increased. However, according to actual requirements, in one embodiment, the positioning holes 311 may be spaced apart from each other and may not be in spatial communication with each other. Each of the pivot seat portions 32 is formed with a slot 321 that extends therethrough in the extending direction of the axis (L), and that is adapted for one end of the respective one of the claw bodies 24 to extend thereinto and for positioning the respective one of the claw bodies 24 such that the claw bodies 24 are respectively and pivotably connected to the pivot seat portions 32.

Referring to FIGS. 5, 7, and 8, the adjusting plate 4 has a core plate portion 41 that has the through hole 410, and that is limited between the core seat portion 31 of the carrying seat 3 and the main rod portion 221 of the core rod 22 (i.e., the core plate portion 41 is placed on the core seat portion 31), and three extension portions 42 that extend radially and outwardly from the core plate portion 41. The extension portions 42 respectively cover top ends of the slots 321. A width of each of the extension portions 42 in a direction perpendicular to a radial direction of the core plate portion 41 gradually decreases as the extension portion 42 extends away from the core plate portion 41. The fixing portion 223 extends through the seat through hole 310 and the plate through hole 410 to be fastened to the end rod portion 222 so that the core plate plate 41 is limited between the core seat portion 31 and the main rod portion 221 and that the opposite ends of the resilient member 5 respectively abut against the main rod portion 221 and the core plate portion 41. The positioning tenon 6 is operable to be inserted into one of the positioning holes 311.

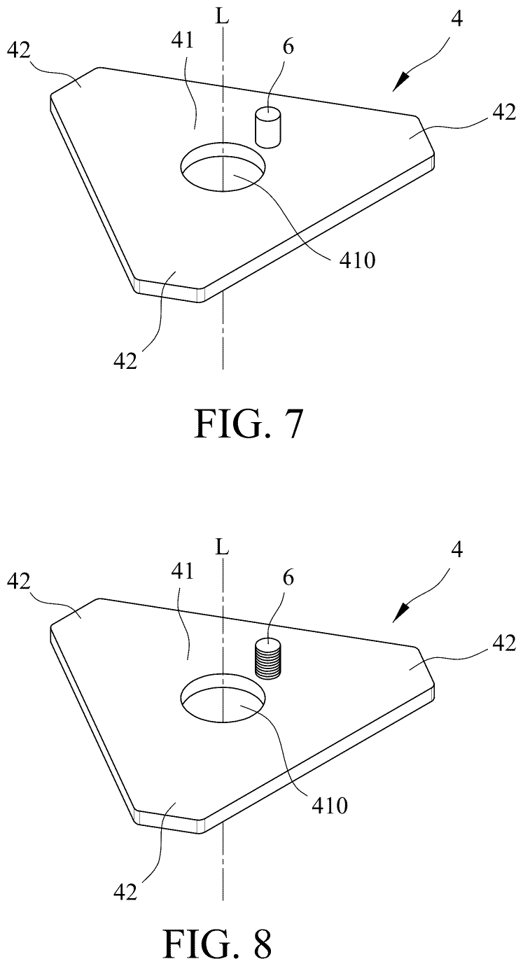

In this embodiment, as shown in FIGS. 5 and 7, the positioning tenon 6 and a bottom surface of the core plate portion 41 of the adjusting plate 4 are integrally formed as one piece (i.e., the positioning tenon 6 extends downwardly from the bottom surface of the core plate portion 41). However, in one embodiment, as shown in FIG. 8, the positioning tenon 6 may be inserted into the core plate portion 41 in the extending direction of the axis (L) and be fastened to the core plate portion 41.

Referring to FIGS. 4 and 5, when the claw adjustment device is in an initial state, the resilient member 5 resiliently biases the core plate portion 41 downwardly in the extending direction of the axis (L) such that the adjusting plate 4 firmly abuts against the carrying seat 3. At this time, as shown in FIG. 4, an extent to which each of the extension portions 42 covers the top end of the respective one of the slots 321 in the extending direction of the axis (L) is maximized. Because degree of opening of the claw device 2 depends on degree of pivot movement of each of the claw bodies 24 relative to the respective one of the slots 321 (i.e., depends on an extent to which each of the claw bodies 24 may pivot upwardly relative to the respective one of the slots 321 until being blocked by the extension portions 42), the claw bodies 24 are quickly blocked by the extension portions 42 when the extent to which each of the extension portions 42 covers the top end of the respective one of the slots 321 in the extending direction of the axis (L) is maximized and when the claw bodies 24 pivot upwardly. Consequently, the degree of opening of the claw device 2 (i.e., the degree of pivot movement of each of the claw bodies 24 relative to the respective one of the slots 321) is minimized.

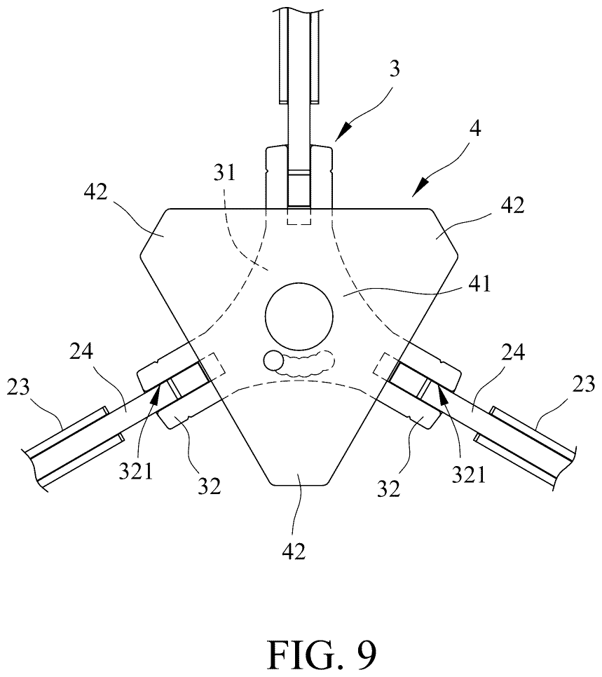

To adjust the degree of opening of the claw device 2, an owner of the crane machine may just pull the adjusting plate 4 upwardly such that the resilient member 5 is compressed, thereby removing the positioning tenon 6 from the one of the positioning hole 311 into which the positioning tenon 6 was inserted. Next, the adjusting plate 4 is operable to rotate relative to the carrying seat 3 about the core rod 22 (i.e., about the axis (L)) so that the positioning tenon 6 may be aligned with another one of the positioning holes 311 and that the extent to which each of the plurality of extension portions 42 covers the top end of the respective one of the plurality of slots 321 may be adjusted. That is to say, when the positioning tenon 6 is aligned with a different one of the positioning holes 311, the extent to which each of the plurality of extension portions 42 covers the top end of the respective one of the plurality of slots 321 is changed accordingly. When the claw bodies 24 respectively swing more upwardly relative to the slots 321, the degree of opening of the claw device 2 becomes greater. As shown in FIG. 9, the top ends of the slots 321 are barely covered by the extension portions 42, and the degree of opening of the claw device 2 (i.e., the degree of pivot movement of each of the claw bodies 24 relative to the respective one of the slots 321) is thus maximized.

Upon completion of the adjustment, as long as the adjusting plate 4 is released, a restoring force provided by the resilient member 5 urges the adjusting plate 4 to firmly abut against the carrying seat 3, and the positioning tenon 6 is inserted into the another one of the positioning holes 311, simultaneously. During a process of the entire adjustment, no tools are needed, and the adjustment may be conveniently completed with only one hand of the owner of the crane machine, which greatly reduces difficulty of operation of the adjustment.

By virtue of the positioning tenon 6 and the resilient member 5 limiting position of the adjusting plate 4, the adjusting plate 4 does not rotate or move upwardly or downwardly relative to the carrying seat 3 when the adjusting plate 4 is not operated so that the adjusting plate 4 is prevented from being offset from its position. In addition, because the core seat portion 31 may have a high density of the positioning holes 311, a number of adjustment settings may be increased according to actual requirements, thereby providing a wider range of the degree of opening of the claw device 2 that may be adjusted. In terms of a configuration of the adjusting plate 4, because the adjusting plate 4 is not formed with positioning holes, the adjusting plate 4 may have a higher structural strength. Thus, during operation of the crane machine, the adjusting plate 4 may not easily be bent or damaged by forces that are exerted by the claw bodies 24.

In summary, the claw adjustment device for the crane machine may simply adjust an extent to which the claw bodies 24 open so as to be suitable for different sizes of prizes that are placed in the crane machine. Furthermore, by virtue of the positioning tenon 6 and the resilient member 5 respectively limiting rotation movement and up-down movement of the adjusting plate 4, the adjusting plate 4 is prevented from being offset from its position. Thus, the purpose of the disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A claw adjustment device for a crane machine adapted to be installed to a claw device of the crane machine, the claw device including a driving member, a core rod that is retractably mounted to the driving member, a plurality of linkage rods that are circumferentially spaced apart from each other about the driving member, and a plurality of claw bodies that are respectively connected to the plurality of linkage rods, each of the plurality of linkage rods having one end that is connected to the driving member, the claw adjustment device comprising:
a carrying seat having a core seat portion that is adapted for abutting against the core rod, and a plurality of pivot seat portions that extend radially and outwardly from the core seat portion and that are adapted to be respectively and pivotably connected to the plurality of claw bodies, the core seat portion having a plurality of positioning holes that open upwardly and that are arranged in a circumferential direction about an axis which extends through the carrying seat, each of the plurality of pivot seat portions being formed with a slot that extends therethrough in an extending direction of the axis and that is adapted for the respective one of the plurality of claw bodies to extend thereinto and for positioning the respective one of the plurality of claw bodies;
an adjusting plate disposed between the carrying seat and the core rod, and having a core plate portion that is placed on the core seat portion of the carrying seat and that has a plate through hole which is adapted for the core rod to extend therethrough, and a plurality of extension portions that extend radially and outwardly from the core plate portion and that respectively cover top ends of the plurality of slots, the adjusting plate being operable to rotate relative to the carrying seat so that an extent to which each of the plurality of extension portions covers the top end of the respective one of the plurality of slots is adjustable;
a resilient member disposed between the core rod and the adjusting plate, and resiliently biasing the core plate portion of the adjusting plate downwardly in the extending direction of the axis; and
a positioning tenon extending downwardly from the core plate portion of the adjusting plate and operable to be inserted into one of the plurality of positioning holes.

2. The claw adjustment device as claimed in claim 1, wherein a width of each of the plurality of extension portions of the adjusting plate in a direction perpendicular to a radial direction of the core plate portion gradually decreases as the extension portion extends away from the core plate portion.

3. The claw adjustment device as claimed in claim 1, the core rod of the claw device including a main rod portion that is inserted into the driving member, an end rod portion that extends downwardly from a bottom end of the main rod portion in the extending direction of the axis and that has a diameter which is smaller than a diameter of the main rod portion, and a fixing portion that is fastened to a bottom end of the end rod portion, wherein the core seat portion of the carrying seat is formed with a seat through hole that is adapted for the fixing portion of the core rod to extend therethrough, the resiliently member being adapted to be sleeved on the end rod portion of the core rod, the plate through hole of the core plate portion of the adjusting plate being adapted for the end rod portion of the core rod to extend therethrough, the fixing portion extending through the seat through hole and the plate through hole to be fastened to the end rod portion so that the adjusting plate is limited between the core seat portion of the carrying seat and the main rod portion of the core rod and that two opposite ends of the resilient member respectively abut against the main rod portion and the core plate portion.

4. The claw adjustment device as claimed in claim 1, wherein the positioning tenon and a bottom surface of the core plate portion of the adjusting plate are integrally formed as one piece.

5. The claw adjustment device as claimed in claim 1, wherein the positioning tenon is inserted into the core plate portion of the adjusting plate in the extending direction of the axis.

6. The claw adjustment device as claimed in claim 5, wherein the positioning tenon is fastened to the core plate portion.

7. The claw adjustment device as claimed in claim 1, wherein the plurality of positioning holes of the core seat portion of the carrying seat are blind holes.

8. The claw adjustment device as claimed in claim 1, wherein the plurality of positioning holes of the core seat portion of the carrying seat are through holes.

9. The claw adjustment device as claimed in claim 1, wherein the plurality of positioning holes of the core seat portion of the carrying seat are in spatial communication with each other in the circumferential direction.

10. The claw adjustment device as claimed in claim 1, a number of the plurality of claw bodies being three, wherein a number of the plurality of pivot seat portions of the carrying seat is three, and a number of the plurality of extension portions of the adjusting plate is three.
